(19) United States
(12) Patent Application Publication
(10) Pub. No.: US 2017/0312560 A1
(43) Pub. Date: Nov. 2, 2017

(54) Water Spray Base for Fire

(71) Applicant: Wen Chang Wang, Tainan City (TW)

(72) Inventor: Wen Chang Wang, Tainan City (TW)

(21) Appl. No.: 15/487,509

(22) Filed: Apr. 14, 2017

(30) Foreign Application Priority Data
Apr. 27, 2016 (TW) 105113015

(51) Int. Cl. A62C 31/24; B05B 15/08

(52) U.S. Cl. CPC A62C 31/24; B05B 15/08

(57) ABSTRACT

A water spray base for fire includes a water inlet pipe, a fixed base, a water outlet pipe, and an adjusting device so as to feature an easy and convenient way of adjusting the angle of elevation or depression of the water spray base and a light weight.

### BACKGROUND OF THE INVENTION

### Field of the Invention

The present invention relates to a water spray base for fire, and more particularly to a simple, convenient, and lightweight water spray base capable of adjusting and controlling the angle of elevation or depression of the water spray base.

### Description of the Related Art

A conventional water spray base for fire is mainly divided into S-shaped and Y-shaped water spray bases according to their functional requirements and the shape of the main pipe. Wherein, the S-shaped water spray base is casted and molded, not just incurring many manufacturing processes only, but also causing a heavy weight and requiring more effort for transportation, and the S-shaped water spray base is in a tubular shape and not vertically erected at the center, but it is biased. If the transversally fixed knob is loosened, the knob may be rotated in a reverse direction by the spray of water. Obviously, there is a risk. Since the Y-shaped water spray base requires a movable water outlet, therefore a flange is required for sectional combination, and such water spray base incurs a higher manufacturing cost and a heavier weight. Obviously, such water spray base requires improvements.

In addition, the conventional water spray base for fire generally has an adjusting device installed under a water outlet pipe for adjusting the angle of elevation or depression of the water spray base, and such water spray base not just has a complicated structure only, but also causes limitation and inconvenience to the operation. Due to the functional requirement and shape, most water spray base is casted and molded, and rough edges are usually formed in the water spray base, and the rough edges cannot be removed easily. As a result, the water spray base produces a flow resistance which causes a poor water spray performance. Obviously, the conventional water spray base requires improvements.

In view of the aforementioned drawbacks of the conventional water spray base for fire, the inventor of the present invention provided a feasible design to overcome the drawbacks of the prior art.

### SUMMARY OF THE INVENTION

Therefore, it is a primary objective of the present invention to provide a simple and convenient water spray base for fire capable of adjusting and controlling the angle of elevation or depression of the water spray base easily for a flexible and convenient operation.

Another objective of the present invention is to provide a lightweight water spray base for fire to facilitate the transportation of the water spray base.

To achieve the aforementioned object, the present invention provides a water spray base for fire, and the water spray base comprises: a water inlet pipe, led and coupled to a water source; a fixed base, pivotally installed to an upper end of the water inlet pipe, and formed by a longitudinal pipe fitting and a transversal connecting pipe, and a knob being installed on a side of the pipe fitting, and an earbud being disposed at an upper end of the connecting pipe; a water outlet pipe, pivotally installed to an upper end of the fixed base, and both sides of the bottom end of the water outlet pipe having a joint pipe each, and an adapter being pivotally coupled to the connecting pipe, and a nozzle being disposed at the upper end of the water outlet pipe, and an earbud being disposed at an upper end of the nozzle; and an adjusting device, comprising: a support stand, mounted on the fixed base, and swingable back and forth; an adjusting rod, installed on both sides of the support stand, and flexibly displaced, and an end of the adjusting rod being pivotally coupled to the nozzle of the water outlet pipe; and a knob, installed to the support stand, for positioning the adjusting rod; thereby, the angle of elevation or depression of the water spray base can be adjusted easily and conveniently, and the water spray base has a light weight.

The technical characteristics, contents, advantages and effects of the present invention will be apparent with the detailed description of a preferred embodiment accompanied with related drawings as follows.

### BRIEF DESCRIPTION OF THE DRAWINGS

FIG. 1 is an exploded view the present invention;

FIG. 2 is a perspective view of the present invention;

FIG. 3 is a side view of the present invention;

FIG. 4 is a cross-sectional view of Section A-A of FIG. 3;

FIG. 5 is a side sectional view of the present invention;

FIG. 6 is a side view showing a first water spraying angle of the present invention; and

FIG. 7 is a side view showing a second water spraying angle of the present invention.

### DETAILED DESCRIPTION OF THE PREFERRED EMBODIMENTS

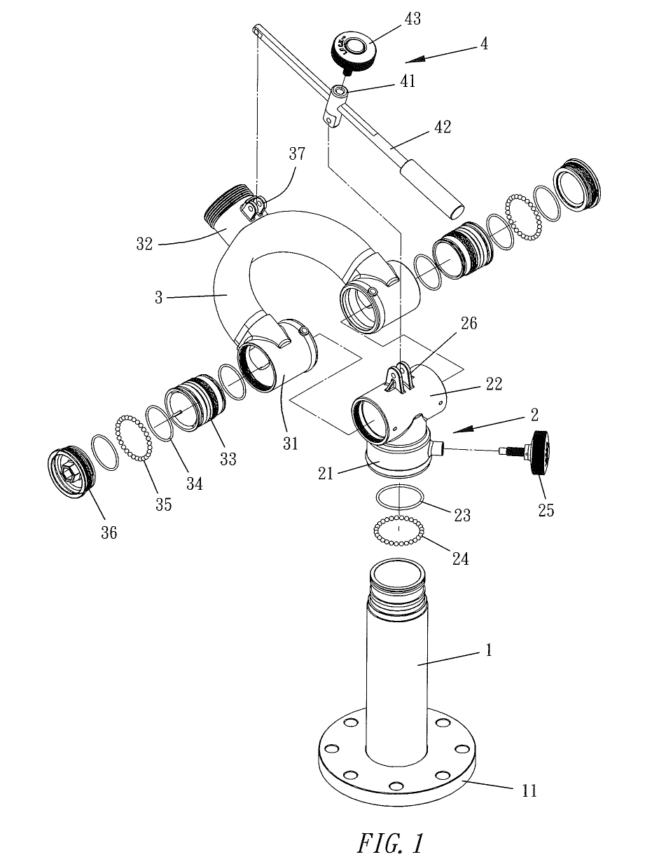

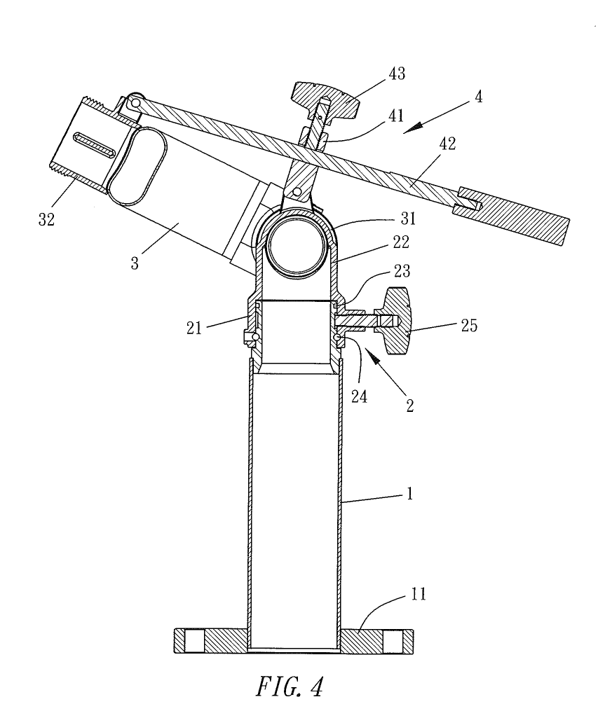

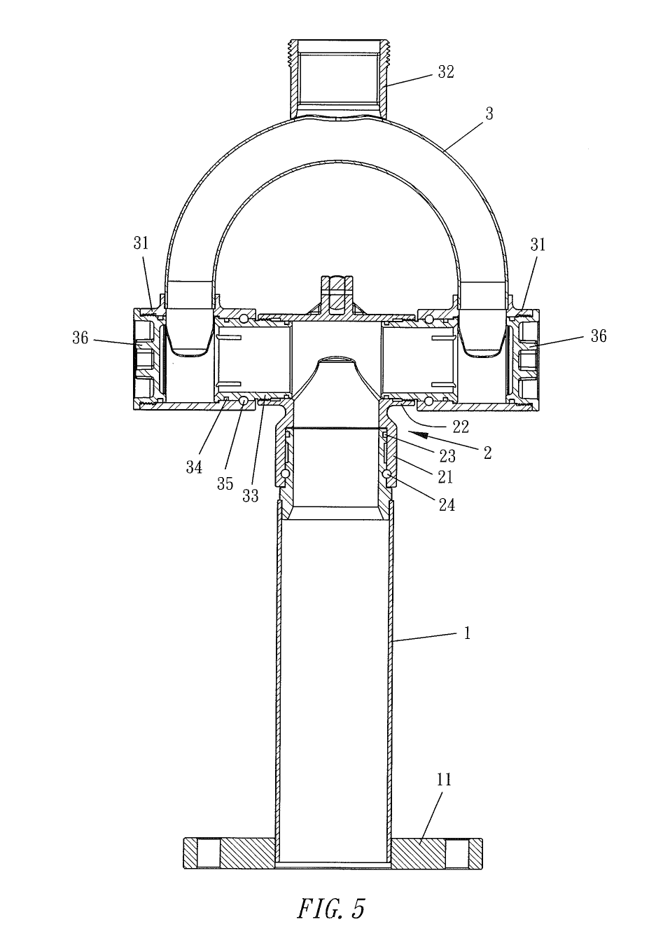

With reference to FIGS. 1 to 5 for a water spray base for fire in accordance with the present invention, the water spray base comprises the following elements:

A water inlet pipe 1 is led and coupled to a water source, and has a disc-shaped base 11 disposed at a bottom end of the water inlet pipe 1.

A fixed base 2 substantially in form of a T-shaped tee is pivotally installed to an upper end of the water inlet pipe 1 and formed by a longitudinal pipe fitting 21 and a transversal connecting pipe 22, and the pipe fitting 21 is pivotally coupled to the water inlet pipe 1 by a waterproof washer 23 and a plurality of steel balls 24, and a side of the pipe fitting 21 is screwed and coupled with a knob 25, so that the fixed base 2 can be rotated or positioned at 360°, and an earbud 26 is disposed at the middle of an upper end of the connecting pipe 22.

A water outlet pipe 3 substantially in form of a C-shaped tee is pivotally coupled to an upper end of the fixed base 2, and both sides of the bottom end of the water outlet pipe 3 have a joint pipe 31 each, and the upper end of the water outlet pipe 3 has a nozzle 32, and the joint pipe 31 is pivotally coupled to the fixed base 2 by means of an adapter 33, two waterproof washers 34 and a plurality of steel balls 35 and disposed on both sides of the connecting pipe 22, and an end cover 36 is provided for sealing the water outlet pipe 3; and an earbud 37 is disposed at the middle of an upper end of the nozzle 32.

An adjusting device 4 includes a support stand 41 pivotally installed to the fixed base 26 and swingable back and forth, and an adjusting rod 42 is installed on both sides of the support stand 41 and has an end pivotally coupled to the earbud 37 (or the nozzle) of the water outlet pipe, and a cut plane is formed at an end surface of the upper side of the support stand 41, and a knob 43 is screwed and coupled with the support stand 41 and provided for flexibly displacing the adjusting rod 42 to drive the nozzle 32 to change its angle of elevation or depression.

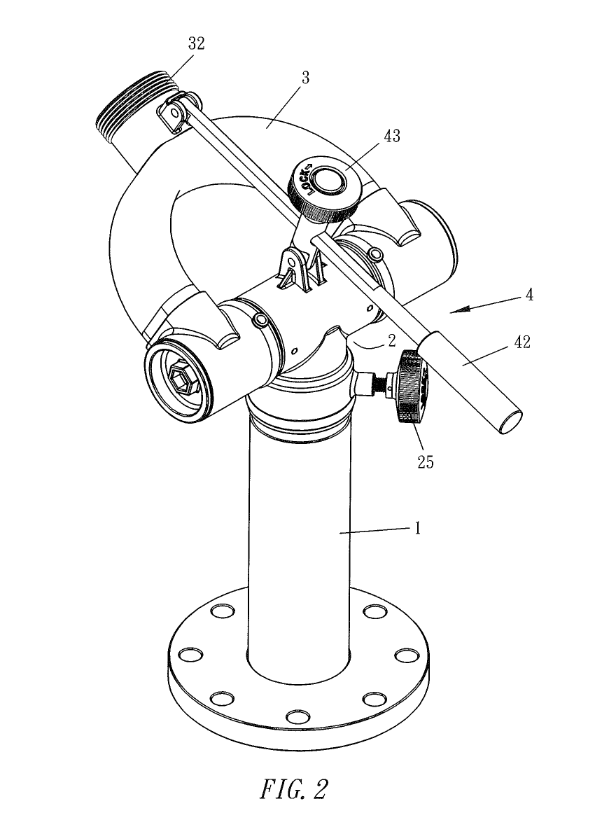

With reference to FIGS. 2 to 5 for the aforementioned structural assembly, the water inlet pipe 1 is supported securely by the base 11, and the fixed base 2 is disposed at an upper end of the water inlet pipe 1, and the water outlet pipe 3 is installed to an upper end of the fixed base 2, and the adjusting device 4 is installed at an upper end of the water outlet pipe 3. When the knob 25 is released, the fixed base 2 and the water outlet pipe 3 is rotated to left or right for 360°, and after the water outlet pipe 3 is rotated to a required angle, the knob 25 is secured to position the water outlet pipe 3.

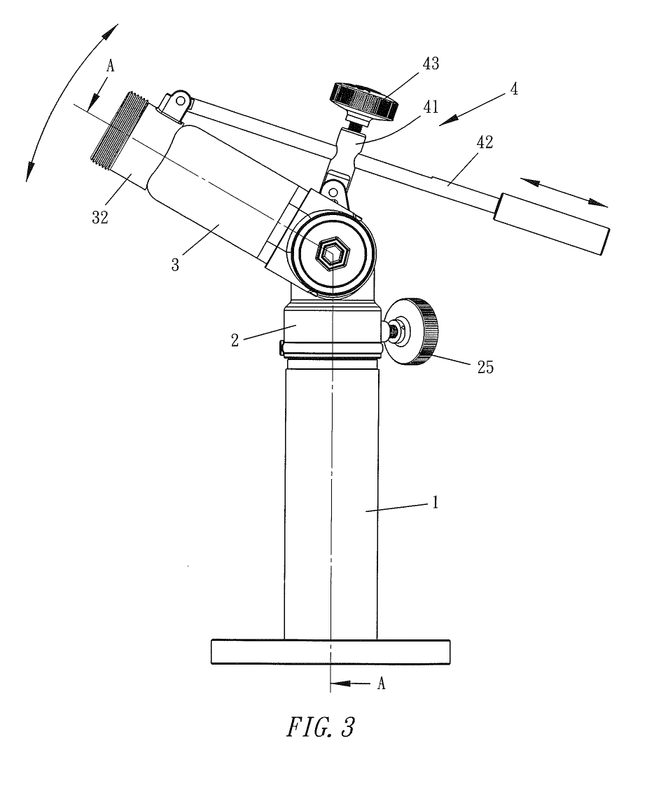

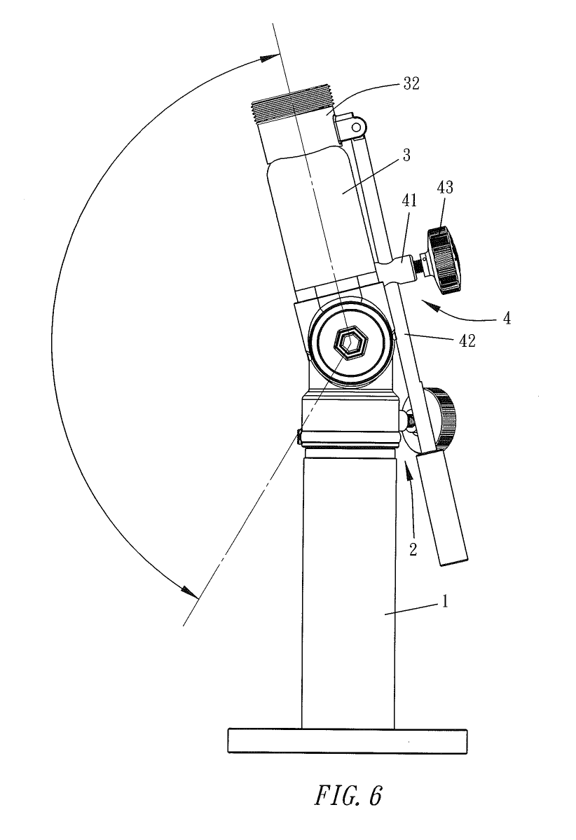

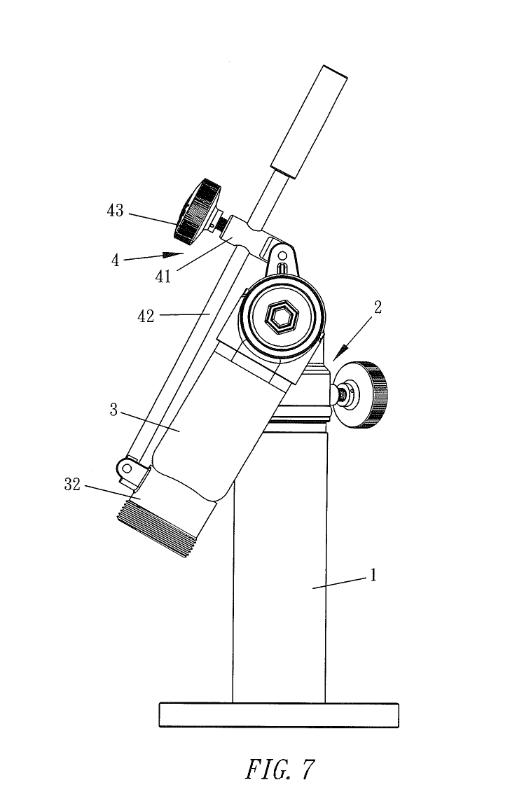

When the knob 43 is released, the support stand 41 may be used as a fulcrum to flexibly displace the adjusting rod 42 to drive the water outlet pipe 3 to adjust the angle of elevation or depression of the nozzle 32 as shown in FIGS. 3, 4, 6 and 7. After the nozzle 32 is adjusted to the required angle of elevation or depression, the knob 43 is secured to position the nozzle 32.

Compared with the prior art, the present invention has the following advantages and effects.

1. The water outlet pipe 3 may be rotated to the left or right for 360° easily, conveniently and quickly by releasing or securing the knob 43.

2. The adjusting rod 42 may be displaced flexibly by releasing the knob 43 to drive the nozzle 32 to change its angle of elevation or depression, and then the knob 43 may be secured and positioned, so as to complete the operation of adjusting and controlling the angle of elevation or depression of the water spray base. The operation is flexible, simple and convenient. In other words, the present invention can adjust the angle of elevation or depression of the nozzle 32 conveniently and easily by turning the knob 43 and stretching the adjusting rod 42.

3. The main components of the present invention includes the water inlet pipe 1, the fixed base 2, the water outlet pipe 3 and the adapter 33 which are pipe members and do not require any flange for combining the pipe members, so that the total weight can be reduced to achieve the lightweight effect, simplify the manufacturing process, and lower the manufacturing cost significantly.

4. Since the water spray base of the present invention is assembled by pipe members, therefore the interior of the water spray base is smooth, and the water flows naturally and smoothly to reduce the resistance and increase the water output quantity.

5. The water outlet pipe 3 is substantially C-shaped, so that water flows on both sides are concentrated and collected by the nozzle 32 before spraying out, and such arrangement not just provides a smooth spray only, but also improves the spraying performance.

While the invention has been described by means of specific embodiments, numerous modifications and variations could be made thereto by those skilled in the art without departing from the scope and spirit of the invention set forth in the claims.

What is claimed is:

1. A water spray base for fire, comprising:
a water inlet pipe, led and coupled to a water source;
a fixed base, pivotally installed to an upper end of the water inlet pipe, and formed by a longitudinal pipe fitting and a transversal connecting pipe, and a knob being installed on a side of the pipe fitting, and an earbud being disposed at an upper end of the connecting pipe;
a water outlet pipe, pivotally installed to an upper end of the fixed base, and both sides of the bottom end of the water outlet pipe having a joint pipe each, and an adapter being pivotally coupled to the connecting pipe, and a nozzle being disposed at the upper end of the water outlet pipe, and an earbud being disposed at an upper end of the nozzle; and
an adjusting device, comprising:
a support stand, mounted on the fixed base, and swingable back and forth;
an adjusting rod, installed on both sides of the support stand, and flexibly displaced, and an end of the adjusting rod being pivotally coupled to the nozzle of the water outlet pipe; and
a knob, installed to the support stand, for positioning the adjusting rod;
thereby, the angle of elevation or depression of the water spray base can be adjusted easily and conveniently, and the water spray base has a light weight.

2. The water spray base for fire according to claim 1, wherein the water outlet pipe is substantially C-shaped.
